(19) United States
(12) Patent Application Publication
(10) Pub. No.: US 2014/0283660 A1
(43) Pub. Date: Sep. 25, 2014

(54) METHOD FOR ESTABLISHING A STRATEGY FOR CUTTING OUT A FLAT SCREEN

(71) Applicants: Christophe Sanglier, Argenteuil (FR); Ella Labonne, Saint Germain en Laye (FR); Aude Maitrot, Paris (FR)

(72) Inventors: Christophe Sanglier, Argenteuil (FR); Ella Labonne, Saint Germain en Laye (FR); Aude Maitrot, Paris (FR)

(73) Assignee: VEOLIA PROPRETE, Nanterre (FR)

(21) Appl. No.: 14/348,654

(22) PCT Filed: Aug. 23, 2012
(86) PCT No.: PCT/FR2012/051927

§ 371 Date: Jun. 2, 2014

(30) Foreign Application Priority Data
Sep. 30, 2011 (FR) 1158778

(51) Int. Cl. H01J 9/52

(52) U.S. Cl. CPC H01J 9/52
USPC 83/13

(57) ABSTRACT

The invention relates to a method for establishing a strategy for cutting out a flat screen (10) including an exposed panel (12) and a frame (11), with a view to upgrading at least a portion of the components thereof, comprising the steps of: determining (110) the dimensions of the exposed panel and the outer dimensions of the screen at least in the plane of the exposed panel; defining (120) the three-dimensional position of the screen in a three-dimensional frame of reference space; defining (130), in the frame of reference, at least one reference line (REF) that is parallel to one of the edges of the frame; and defining (140) at least one cutting line (CUT) of the frame, from which the distance (DC) to the reference line is constant and predetermined.

The present invention relates to the preparation for the deconstruction, that is to say the dismantling of flat screens.

It applies to any type of flat screen, for computer or television type screens, whether it be screens with a liquid crystal panel (LCD Liquid Crystal Display) and backlight lamps (CCFL, LED or other) or other technologies of screens, such as:
Plasma
OLED (organic light emitting diode)
SED (Surface-conduction Electron-emitter Display)
FED (Field Emission Display)
OEL (Organic Electroluminescent)
PLED (polymer light-emitting diodes), or
PHOLED (Phosphorescent Organic Light-Emitting Diode)

For more brevity, reference will be substantially made with regard to LCD screens.

Typically, a flat screen 10 comprises structural members and functional members.

Functional members comprise the various members which allow for viewing images on the screen, that is to say, particularly a viewing panel 12 or “panel”, at least one electronic card 14 and for example polarization filters 16, a possible light diffuser 17 and backlight lamps 13, most often located under the panel.

The structural members comprise a frame 11 and a framework 15. The framework, generally metallic, allows to bind certain at least functional members and may envelope certain functional members such as the panel, filters, possible diffusers, and lamps. The frame usually plastic, forms an outer envelope for the panel and may conceal or contain other functional screen members, for example the loudspeakers.

The frame 11 partially covers the panel on its periphery, according to a substantially rectangular shape in such a manner that the visible panel not covered by the frame is called “exposed panel”. The frame substantially has an aesthetic function and sometimes a structural function when various members of the screen are directly fastened onto it.

The panel and/or the lamps may contain polluting elements.

In order to destroy or decontaminate these flat screens at the end of their service life, there are industrial methods of at least partially grinding, these screens during which the panel and/or the backlight lamps are usually destroyed or partially damaged. Hence, such methods can cause the release of gases and toxic substances, such as mercury, for example, in the air, on the ground, or in direct contact with the constituents of the screen that are liable to be recycled.

This causes the difficulty of recovering the recoverable components, particularly liquid crystals, and metals, particularly indium from the screen.

Also, more particularly, the invention relates to according to a first of its purposes a method for establishing a strategy for cutting out a flat screen comprising an exposed panel and a frame, with a view to recycling at least a portion of the components thereof, characterized in that it comprises steps consisting in:
determining the dimensions of the exposed panel and the outer dimensions of the screen at least in the plane of the exposed panel,
defining the three-dimensional position of the screen in a three-dimensional frame of reference,
defining, in the frame of reference, at least one reference line that is parallel with one of the edges of the screen frame, and
defining at least one cutting line of the frame, from which the distance to the reference line is constant and predetermined,
and a step of detecting the presence of at least one characteristic member of the screen from among a set comprising:
a specific connector,
a loudspeaker,
the brand name and/or the name of the screen model, and
a bar code or a data matrix.

What is meant by “cutting strategy” is the definition of the three-dimensional coordinates of at least one cutting line in the three-dimensional frame of reference.

Thanks to the invention, the cutting line can follow the shape of the frame, including when it is deformed.

Preferably, the reference line is a straight line.

Preferably, the reference line is parallel with the plane of the panel or perpendicular to the plane of the panel.

The reference line may be defined on the screen, that is to say, on the exposed panel or on the frame or outside the screen.

In an embodiment, the reference line is the intersection between the exposed panel and one of the internal edges of the screen frame.

When the step of detecting the presence of at least one characteristic member of the screen is implemented, it can be further provided at least one of the steps consisting in:
defining the position of the specific connector,
measuring the dimensions of the loudspeaker and defining its position in the frame of reference,
carrying out optical recognition of the brand and/or the brand name,
carrying out optical recognition of the bar code or the data matrix.

It can also be provided to define the position in the frame of reference of the brand and/or the name of the model as well as the position of the bar code or data matrix.

In an embodiment, it can be further provided steps consisting in

comparing with reference values in a data base at least one of the information from among
the dimensions of the exposed panel and the outer dimensions of the screen,
the presence of a characteristic member of the screen,
the position of the characteristic member, and
the dimensions of the characteristic member; and
deduce from the database, the value of a set of at least one corresponding value of the predetermined distance from the cutting line.

For example, the method may comprise a step consisting in comparing in addition to database reference values, one at least of the members from among:
existence of a specific connector,
position of a specific connector,
existence of a loudspeaker,
position of a loudspeaker,
dimensions of a loudspeaker
existence of a brand name, and its identification,
existence of the screen model name, and its label,
existence of a bar code, and its significance,
existence of a data matrix, and its significance,
   to deduce from the database the value of a set of at least one corresponding value of the predetermined distance from the cutting line.

Preferably, when several predetermined distance values are deduced, the method further comprises a step of selecting the greatest distance value from among the set of values.

In an embodiment, it is further provided a step of graphic representation visible to the unaided eye of the cutting line on a graphic interface and/or on the screen frame.

In an embodiment, it is provided a laser profilometry step, for determining at least the dimensions of the exposed panel and the outer dimensions of the screen.

Preferably, the laser profilometry step is implemented on the front side (that is to say, the viewing side) of the screen, the laser beam covering the exposed panel and the frame.

In an embodiment, it is further provided, a step of cutting the screen along the cutting line.

Preferably, it is provided that the cut out is carried out along a predefined cutting depth.

In one embodiment, it is provided that the cutting depth is linked to the detection of at least one characteristic member of the screen.

According to another of its purposes, the invention relates to a computer program comprising program code instructions for the execution of the steps of a method such as defined beforehand when said program is executed on a computer.

Thanks to the invention, at least some structural and/or functional members may be disengaged, and the integrity at least of the panel may be kept.

The invention is advantageously compatible with all types of screen: television sets and computer monitors (including touch tablets, APD's, smart phones; satellite navigation devices, etc.)

The invention may advantageously be implemented whatever the state (new, damaged, used), the size and weight of the screen.

Other features and advantages of the present invention will become apparent upon reading the following description given by way of non limiting example made with reference to the accompanying drawings in which:

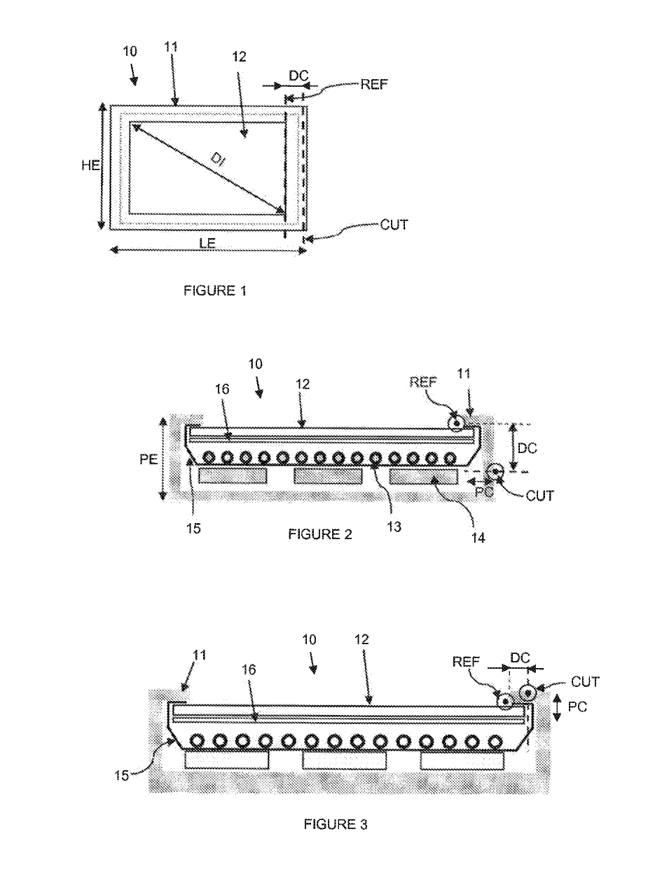

FIG. 1 illustrates a front view of a flat screen, with exposed panel, with a reference line and a cutting line,

FIG. 2 illustrates a transversal cross-section of a flat screen for a lateral cutting strategy,

FIG. 3 illustrates a transversal cross-section of a flat screen for a front cutting strategy,

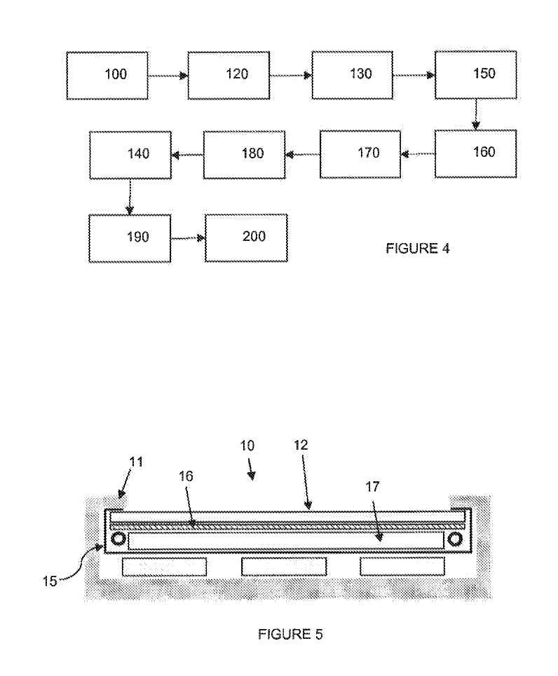

FIG. 4 illustrates an embodiment of the method according to the invention, and

FIG. 5 illustrates a transversal cross-section of a flat LCD screen.

The inner configuration of a flat screen 10, for example LCD, varies from one screen to another and from one type of screen to another. As illustrated in FIG. 5, in an LCD screen, the lamps are in the background with respect to the panel. They are either uniformly distributed behind the panel, or distributed, at the periphery but are always set back with respect to the plane of the panel.

For example, there are screens with direct backlight lamps, for example LCD screens in which the backlight lamps (CCFL mercury lamps or LED lamps called “full LED” are distributed behind the entire surface of the panel (FIG. 2, FIG. 3).

In this case, it is provided to cut the frame and possibly also the additional metallic framework. As for plasma technologies, one cannot strictly speak of direct or indirect lighting. In fact, in a plasma, it is the plasma panel which is a light source but for the cut out, a plasma screen can be assimilated to a direct backlight screen.

For this type of inner configuration, a front cut can be made, as illustrated on FIG. 3, that is to say, to cut out the screen frame by the front side (viewing side), around the panel, on a portion at least of the periphery of the frame in the plane of the exposed panel. According to the cutting depth PC, a front cut may also allow to cut the metallic framework 15 at the same time as the frame 11.

The screen frame may also be cut according to a mixed technique consisting in cutting out the screen frame
according to a front cut, by the front side (viewing side), along two lines located in the plane of the exposed panel on two opposite sides of the frame, and
according to a lateral cut, as illustrated in FIG. 2, by the sides, along two lines located in planes perpendicular to the exposed panel, on the two other sides of the frame.

Preferably, the cutting lines CUT by the front side are parallel and also parallel, with the lamps 13.

Such screens are typically of television screen type.

There are also screens with indirect backlights, for example LCD screens, in which the backlight lamp(s) (mercury lamps CCFL or LED strips, for example) are not distributed over the entire surface but concentrated in the periphery of the panel on one or on several sides thereto and set back with respect to the plane of the panel.

In this case, the lamps are secured to a metallic structure which envelops the periphery of the panel and the filters, in the form of a single block. The metallic structure may be the aforementioned metallic framework 15 or distinct thereto: for example the framework which directly encapsulates the panel, the filters and the lamps and the metallic structure which encompasses the framework.

Due to its individual compact structure, it is preferable that the single block be disengaged from the screen in a block, that is to say, in its integrity. Hence, it is provided to cut out the frame 11 (and the distinct metallic framework when it exists) in order to remove the single block. The single block may be treated later on in other upgrading methods. On FIG. 2 and FIG. 3, the metallic framework 15 is the single block.

For this type of inner configuration, a lateral cut can be carried out, that is to say to cut the frame of the screen from the sides (perpendicular to the exposed panel), over the entire periphery of the frame. This allows to release the single block. A lateral cut may also be implemented for mounted screens.

Such screens are typically of computer screen type.

There is a relationship between the screen type and the inner configuration thereto. Knowing the type of screen allows to know its inner configuration, hence to determine if the cut must be frontal (to be done on the front side) and/or lateral (on the sides of the screen). Knowing the technical features of a screen, that is to say, some at least of its characteristic members may allow to adjust the cutting parameters (distance to the reference line, cutting depth).

For recycling at least a portion of the members constituting a flat screen at the end of its service life, a screen is received in its current state.

It may be provided a prior preparation step 100. In this case, the preparation consists for example in removing the leg, or support, from the screen; remove possible wires as well as possible aesthetic (additional glass plate covering the entire front side, stickers, etc.) or functional members such as a touch panel for example.

The preparation is preferably carried out by an operator.

The screen is then clamped on a clamping system, from which it is made integral. This placing may be achieved:
Manually, for example by an operator who handles the screen by hand and places it on the clamping system;
Automatically, for example by a robot provided with a gripping tool (pliers, suction pad) which takes the screen and places it on the clamping system; or
Semi-automatically, for example by an operator who operates a handling system which places the screen on the clamping system.

It is thus provided to determine the dimensions of the exposed panel, that is to say the inner dimensions of the frame 11 in the plane of the panel, for example the inner diagonal. DI, and the outer dimensions of the screen at least in the plane of the exposed panel, which corresponds to the outer dimensions LE, HE of the frame, it may also be provided to measure the outer dimensions of the screen in a plane perpendicular to that of the exposed panel, thus corresponding to the thickness PE (or depth) of the frame.

The determination step 110 may be implemented by any tool for measuring dimensions or by laser profilometry (described later on) it can be at least partially implemented by the clamping itself which allows to determine the outer dimensions of the frame.

It is also provided to define 120 the three-dimensional position of the screen in a three-dimensional frame of reference.

The three-dimensional position of the screen may be determined by the actual clamping in a three-dimensional frame of reference corresponding to the three-dimensional frame of reference of the clamping system, or determined by a laser profilometry system.

The laser profilometry system and the cutting system both described later on, comprise their own three-dimensional frame of reference. The clamping system may comprise its own three-dimensional frame of reference. The skilled person knows of the changes of frames of reference. Hence, it is considered indistinctly one of the three-dimensional frames of reference, whichever one it is.

Once the dimensions of the screen and its three-dimensional position determined, it is provided to define 130 in the frame of reference at least one reference line REF.

The reference line REF may be adapted to the shape of a side of the frame. That is to say that it is straight when the frame is straight and curved when the frame is curved (by construction or by deterioration).

The reference line REF may be determined on the screen (that is to say on the exposed panel 12 or on the frame 11), or outside it. Preferably, the reference line is parallel with one of the outer or inner edges of the frame. In this instance as illustrated in FIG. 2, it corresponds to the intersection between the exposed panel 12 and one of the inner edges of the screen frame, it is thus parallel with the plane of the panel.

Once the reference line REF is determined, it is provided to define 140 in the frame of reference at least one cutting line CUT of the frame from which the distance DC with respect to the reference line (possibly in a plane parallel with the exposed panel or in a plane perpendicular to the exposed panel) is constant and predetermined. The reference line REF and the cutting line CUT are thus parallel.

The knowledge of the position of the reference line allows to define the position of the cutting line, hence to be able to possibly obtain a curved cutting line when the reference line is curved.

As seen previously, the cutting line CUT of the frame may be localized in a plane parallel with that of the exposed panel (front viewing side, see FIG. 2) and/or on a lateral side (FIG. 3), that is to say in a plane perpendicular to the plane of the panel.

The aforementioned laser profilometry step allows to obtain the (three-dimensional) topography and the three-dimensional position of the screen. It is advantageous as it is rapid, inexpensive and non intrusive.

A laser profilometry system (not illustrated) is calibrated and comprises a laser and a camera. The laser projects a flat beam onto the screen resulting in a line of light thereto. The laser is inclined at a given angle, for example by 30° to 45° with respect to the optical axis of the camera which scans an area where the laser line is reflected, in such a manner as to image the deformations of the line due to the screen relief, that is to say the geometry of the exposed panel and the frame. Preferably, the optical axis of the camera or the plane of the laser beam is orthogonal to the plane of the exposed panel.

The movement of the camera is integral with the movement of the laser, for example by being both carried by a robotized arm (not illustrated). This arm allows to produce a translation movement (scanning) of the camera-laser assembly.

A screen may be scanned by the laser once or several times.

In an embodiment, the robot may make the camera-laser assembly swivel. It is possible to carry out a first laser profilometry step on one side of the screen in one direction, then a second laser profilometry step on another side according to the rotation angle: for example of the opposite side in the other direction for a 180° rotation, or along a perpendicular side for a 90° rotation.

The camera acquires a set of images (sampling) during the movement. On each image, a more or less deformed line, and possibly discontinuous can be seen. This line, called profile, represents the deformation of the laser line on the screen relief.

The obtained profile images allow, by known image processing algorithms and thanks to the laser profilometry calibration system to reconstruct the three-dimensional profile of the screen, that is to say to determine at least the dimensions of the exposed panel and the outer dimensions of the screen. They can also allow to determine the three-dimensional position of the screen in a three-dimensional frame of reference.

The dimensions and three-dimensional position of the inner edges of the frame may hence be known by laser profilometry and in one embodiment, the intersection between the exposed panel and an inner edge of the screen frame serves as reference line.

The outer dimensions or the exposed panel of certain screens sometimes allow to deduce without ambiguity the type of screen.

For example, for screens of size less than 20 inches, it is likely that the screen has indirect backlighting, a lateral cut can be made.

For screens of size greater than 26 inches, it is likely that the screen has direct backlighting, a front or mixed cut can be made.

For screens of intermediate size, it is sometimes difficult to deduce without ambiguity the type of screen. However, applying a cutting strategy that is inappropriate for the screen type may damage the single block or jeopardize the integrity of members containing pollutants.

In order to help dissipate the possible ambiguity, it can be provided a step 150 of detecting, in this instance optically, the presence of at least one characteristic member of the screen.

The characteristic member may be a specific connector such as a 21-pin connector or an antenna plug of which the presence allows to deduce that it is likely to be a television type screen.

The characteristic member may be a loudspeaker or grid, particularly, on the front side or rear side of the screen, of which the presence allows to deduce that it is likely to be a television type screen.

The presence of a brand name (possibly in the form of a logo on the screen or a sticker) and/or name of the model of the screen may allow to identify the screen, hence whether it is a television or computer type screen.

The presence of a bar code or a data matrix and the optical reading thereof allows to identify the screen type.

The screen technology (LCD, CCFL, LED, Plasma, . . . ) may also be identified by the operator.

The position and/or dimensions of a characteristic member may also be determined, particularly by laser profilometry.

Preferably, at least one of the information from among the presence of a characteristic member of the screen, the position, and the dimensions thereof is registered in a database.

The optical recognition may be implemented by the operator and/or the laser profilometry step. The optical reading of the bar code/data matrix may be implemented by any type of reader, for example infrared.

In one embodiment, it is further provided a step consisting in comparing 160 the dimensions of the exposed panel and the outer dimensions of the screen with reference values from the database, and when these exist, to further compare with reference values from the database, one at least of the members from:
existence of a specific connector,
position. of a specific connector,
existence of a loudspeaker,
position of a loudspeaker,
dimensions of a loudspeaker,
existence of a brand name, and identification (label/logo) thereto,
existence of a name of the model of the screen, and label thereto,
existence of a bar code, and its significance,
existence of a data matrix, and its significance.

All this information at least allows to help identify a screen type. It is possibly foreseeable to identify a precise model of screen.

The database includes technical, features associated with a set of models of screens, comprising one at least of the aforementioned members as well as the different dimensions of the frame, the thickness of the frame, etc. There is in the database, a correspondence between certain at least of these information and at least one corresponding value of the predetermined distance from the cutting line, the distance being calculated or determined with respect to the previously determined reference line. More particularly, the predetermined distance DC from the cutting line may be determined with respect to another reference line. A simple change of frame of reference between the two reference lines allows in this case to calculate the distance with respect to the previously determined reference line. Preferably, in this case the two reference lines are parallel.

According to one at least of the aforementioned members, it may thus be searched in the database the corresponding screen model (s) and their associated technical characteristics.

The database allows to deduce 170 the value of a set of at least one corresponding value of the predetermined distance DC from the cutting line and/or the cutting depth PC.

It may happen that several values of predetermined distances be deduced from the database. In this case, it may advantageously provide a step of selecting 180 the greatest distance value from among the set of values.

Thanks to the invention, one may thus link the predetermined distance value to the screen type, and possibly also the position of a characteristic member, or the dimensions thereof.

Thus, for a front cut out for example, knowing at least the position of the reference line, the inner diameter DI of the screen, and the outer dimensions LE, HE of the screen 11; the database allows for example no know the real size of the panel, that is to say no define a cutting distance DC such that the cutting line CUT be located beyond the external portion of the panel (concealed by the frame 11 and represented in dots FIG. 1), such that the cut out 200 of the frame may be implemented without risk of cutting the panel 12 (FIG. 1 and FIG. 3) Likewise, for a lateral cut out (FIG. 2) the database allows for example to determine the minimum cutting distance DC such that the cutting line CUT be located beyond the single block or beyond the lamps 13 so as to avoid damaging them.

The three-dimensional position of the reference line and the three-dimensional position of the cutting line being known, it may be further provided a step of graphically representing 190 the cutting line CUT, such that it be visible by the unaided eye, thus allowing an operator to visually validate the cutting line before the step of cutting 200 the frame. For example, the cutting line CUT may be represented on a graphic interface, particularly the one used for laser profilometry. The cutting line CUT may be directly represented on the frame 11 of the screen, for example by laser lighting or labeling (thermal, with ink, etc.).

It is also provided a step of cutting out 200 the screen along the cutting line CUT, thanks to the coordinates of the cutting line, determined with respect to the reference line REF allowing to guide the trajectory of an automatic cutting tool, or thanks to (visual or automatic) optical recognition of the graphic representation of the cutting line which allows to guide the trajectory of a manual or automatic cutting tool. Thus, being useful particularly in cases where the robot holding the cutting tool is only guided by means of an optical recognition system, for example of the laser line CUT traced on the screen.

Preferably, the cut out is carried out according to a predefined cutting depth PC, by means of a cutting system.

The cutting depth PC is for example defined as being the penetration depth of a cutting tool into the screen with respect to the cutting line and along it.

Preferably, the cutting depth PC is typically in the magnitude of several millimeters. It may be provided that it be linked to the detection of at least one characteristic member of the screen.

The cutting system comprises a manual or automatic cutting tool, for example a circular saw, a water jet, a laser, etc.

1.-10. (canceled)

11. A method for cutting out a flat screen comprising an exposed panel and a frame, with a view to recycling at least a portion of the components thereof, the method comprising:
determining the dimensions of the exposed panel and the outer dimensions of the screen at least in the plane of the exposed panel,
defining the three-dimensional position of the screen in a three-dimensional frame of reference,
defining accordingly in the frame of reference, at least one reference line that is parallel with one of the edges of the frame,
defining at least one cutting line of the frame, from which the distance to the reference line is constant and predetermined,
comparing the dimensions of the exposed panel and the outer dimensions of the screen with reference values from a database, and
deducing the value of a set of at least one value of the distance from the cutting line to the reference line.

12. The method according to claim 11, comprising
A step of optically detecting the presence of at least one characteristic member of the screen from among a set comprising:
a specific connector, a loudspeaker, the brand name and/or the name of the screen model, and a bar code or a data matrix.

13. The method according to claim 12, wherein at least one of the steps comprises:
defining the three-dimensional position of the specific connector,
determining the dimensions of the loudspeaker and defining its position in the frame of reference,
carrying out an optical recognition of the brand and/or name of the model,
carrying out an optical recognition of the bar code or the data matrix.

14. The method according to claim 13, further comprising:
comparing to reference values in the database at least one of the information from among:
the presence of a characteristic member of the screen,
the position of the characteristic member, and
the dimensions of the characteristic member for identifying a screen type; and
deducing from the database, the value of a set of at least one corresponding value of the predetermined distance from the cutting line.

15. The method according to claim 14, in which when several predetermined distance values are deduced, the method further comprises a step of selecting the greatest distance value from among the set of values.

16. The method according to claim 11, further comprising a step of graphic representation visible to the unaided eye, of the cutting line, on a graphic interface and/or on the frame of the screen.

17. The method according to claim 1, comprising a laser profilometry step, for determining at least the dimensions of the exposed panel and the outer dimensions of the screen.

18. The method according to claim 1, further comprising a step of cutting out the screen along the cutting line.

19. The method according to claim 18, in which the cutting is carried out according to a predefined cutting depth.

20. The method according to claim 19, in which the cutting depth is linked to the detection of at least one characteristic member of the screen.
